(19) United States
(12) Patent Application Publication
(10) Pub. No.: US 2015/0175049 A1
(43) Pub. Date: Jun. 25, 2015

(54) TRUCK

(71) Applicant: BOSICH (1955) Pty. Ltd., Subiaco, Western Australia (AU)

(72) Inventor: Milan Edgar Bosich, City Beach (AU)

(21) Appl. No.: 14/416,888

(22) PCT Filed: Aug. 23, 2013
(86) PCT No.: PCT/AU2013/000937

§ 371 Date: Jan. 23, 2015

(30) Foreign Application Priority Data
Jul. 27, 2012 (AU) 2012903238

(51) Int. Cl. B60P 3/42; B60P 3/12; B62D 53/06; B62D 53/08

(52) U.S. Cl. CPC B60P 3/42; B62D 53/08; B60P 3/125; B62D 53/061

(57) ABSTRACT

A tow vehicle comprising a chassis and means for towing a vehicle or trailer attached to the chassis, the means for towing comprising a tow arm adapted to receive the vehicle to be towed, and a hitch attached to the chassis of the tow vehicle, wherein the tow arm is adapted to provide access to the hitch to allow attachment of the trailer to be towed to the hitch.

### TECHNICAL FIELD

The present invention relates to vehicles.

The invention has been devised particularly, although not necessarily solely, in relation to tow vehicles and load carrying vehicles.

### BACKGROUND ART

The following discussion of the background art is intended to facilitate an understanding of the present invention only. The discussion is not an acknowledgement or admission that any of the material referred to is or was part of the common general knowledge as at the priority date of the application.

FIG. 1 shows an arrangement of a truck 10 adapted for towing a truck 12. The truck 10 comprises a tow arm 14 adapted to receive the front bumper of the truck 12. For this, the tow arm 14 comprises a tow attachment 16 onto which the front bumper of the truck 12 is attached.

The tow arm 14 is pivotally attached to the chassis of the truck 10. This allows selectively displacing the tow arm 14 between a lowered position and a raised position. The fact that the tow arm 14 can be selectively located at a first stage in the lowered position allows fastening of the truck 12 to the tow attachment 16 of the tow arm 14. After attachment of the truck 12 to the truck 10, the tow arm may be located in the raised position to allow towing of the truck.

The truck 10 shown in FIG. 1 is adapted to tow a lowboy trailer. Lowboy trailer typically are flatbed carriers having a gooseneck connection to the truck 10. The truck 10 comprises a fifth wheel or hitch 18. The hitch 18 provides the link between the gooseneck connection of the trailer and the truck 10.

The hitch 18 is located on the tow arm 14. As shown in FIG. 1, the tow arm 14 comprises two sections 20 and 22. Sections 20 and 22 are perpendicularly arranged with respect to each other. Section 20 is pivotally attached to the chassis of the truck 10. Section 20 comprises the hitch 18 and section 22 comprises the tow attachment 16. When the tow arm 14 is located in the lowered position, the section 20 is arranged horizontally with respect to the ground on which the truck 10 is supported. The section 22 extends perpendicularly to the section 20 such that the tow attachment 16 protrudes from the rear of the truck. In this arrangement, the gooseneck connection of the trailer may be attached to the hitch 18 to allow towing of the trailer.

As mentioned before, the hitch 18 is attached to the tow arm 14. This is particularly disadvantageous because during towing of the trailer the load provided by the trailer is applied directly to the tow arm 14. Typically, this damages the tow arm 14. Also, the continues application of the load to the tow arm 14 provided during towing to the trailer may wear out the connection between the tow arm 14 and the chassis of the truck 10.

Further, as mentioned before, the tow attachment 16 protrudes from the rear end of the truck 10. The fact that the tow attachment 16 protrudes from the rear of the truck is inconvenient. This is particularly true when the trailer is being presented to the rear of the truck 10 for fastening of its gooseneck connection to the truck 10.

It is against this background that the present invention has been developed.

### SUMMARY OF INVENTION

According to a first aspect of the invention there is provided a tow vehicle comprising a chassis and means for towing a vehicle or trailer attached to the chassis, the means for towing comprising a tow arm adapted to receive the vehicle to be towed, and a hitch attached to the chassis of the tow vehicle, wherein the tow arm is adapted to provide access to the hitch to allow attachment of the trailer to be towed to the hitch.

Preferably, the tow arm is pivotally attached to the chassis. This allows selectively displacing the tow arm between a raised position and a lowered position.

Preferably, the tow arm comprises a front section and a rear section, the front section being pivotally attached to the chassis and the rear section being adapted to attach the vehicle to be towed.

Preferably, the front section of the tow arm comprises a plurality of side beams arranged in a spaced apart relationship with respect to each other to define a clearance between the side beams, the clearance providing access to the hitch.

Preferably, each of the side beams are pivotally attached to the chassis.

Preferably, the hitch is attached to the chassis at a location located between the side beams. This arrangement allows the hitch to pass through the clearance defined by the side beams during pivoting of the tow arm. In this manner is provided access to the hitch when the tow arm is located in the lowered position.

Preferably, the chassis of the tow vehicle comprises a plurality of plate sections arranged in a spaced apart relationship with respect to each other, the hitch being attached between the plate sections and each of the side beams attached to one of the plate sections such that the hitch is located between the side beams.

Preferably, a support base is attached between the plate sections, the base being adapted to receive the hitch.

Preferably, the rear section of the tow arm comprises a tow attachment adapted to attach the vehicle to be towed.

Preferably, the tow attachment comprises a bumper adaptor for attaching the bumper of the vehicle to be towed.

Preferably, the tow attachment is pivotally attached to the rear section of the tow arm. This allows selectively displacing the tow attachment between a raised position and a lowered position.

Preferably, the trailer to be towed comprises a lowboy trailer.

Preferably, the vehicle to be towed comprises a large dump truck.

According to a second aspect of the invention there is provided towing means for attachment to a chassis of a tow vehicle, the towing means comprising a tow arm and a hitch, the hitch attached to the chassis of the tow vehicle, wherein the tow arm is adapted to provide access to the hitch to allow attachment of a trailer to be towed to the hitch of the tow vehicle.

Preferably, the tow arm comprises a front section and a rear section, the front section being pivotally attached to the chassis and the rear section being adapted to attach a vehicle to be towed.

Preferably, the front section of the tow arm comprises a plurality of side beams arranged in a spaced apart relationship with respect to each other to define a clearance between the side beams, the clearance providing access to the hitch.

Preferably, the tow arm is pivotally attached to the chassis.

According to a third aspect of the invention there is provided towing means for attachment to a chassis of a tow vehicle, the towing means comprising a tow arm adapted to receive a vehicle to be towed, the towing means comprising a front section and a rear section, the front section being pivotally attached to the chassis and the rear section comprising a tow attachment adapted to attach the vehicle to be towed, wherein the tow attachment is pivotally attached to the rear section of the tow arm.

According to a fourth aspect of the invention there is provided a tow arm for attachment to a tow vehicle, the tow arm comprising a front section and a rear section, the front section being adapted to be pivotally attached to a chassis of a tow vehicle and the rear section being adapted to attach a vehicle to be towed by the tow vehicle, wherein the front section comprises a plurality of side beams arranged in a spaced apart relationship with respect to each other to define a clearance between the side beams.

Preferably, the rear section of the tow arm comprises a tow attachment adapted to attach the vehicle to be towed:

Preferably, the tow attachment is pivotally attached to the rear section of the tow arm.

According to a fifth aspect of the invention there is provided a tow arm comprising a front section and a rear section, the front section being pivotally adapted to be attached to a chassis of a tow vehicle and the rear section comprises a tow attachment adapted to attach a vehicle to be towed wherein the tow attachment is pivotally attached to the rear section of the tow arm.

Preferably, the front section comprises a plurality of side beams arranged in a spaced apart relationship with respect to each other to define a clearance between the side beams.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a perspective view of a tow truck towing a truck;

FIG. 2 is a perspective view of a truck according to the first embodiment;

FIG. 3 is a sectional perspective view of the truck shown in FIG. 2;

FIG. 4 is a sectional side view of the truck shown in FIG. 2 having the tow arm in the raised position;

FIG. 5 is a sectional side view of the truck shown in FIG. 2 having the tow arm in the raised position;

FIG. 6 is a side view of the truck shown in FIG. 2 converted to a primer mover of a lowboy trailer; and

FIG. 7 is a sectional side view of the truck shown in FIG. 6.

### DESCRIPTION OF EMBODIMENTS

FIG. 2 shows a truck 30 in accordance with an embodiment of the invention. The truck 30 comprises a front section 32 and rear section 34. The front section 32 comprises the engine of the truck 30 and the cabin for operating of the truck 10. The rear section 34 comprises the means for towing.

The truck 30 in accordance with the present embodiment of the invention is adapted to be converted to function either as a tow truck for towing trucks, in particular, large dump trucks or a prime mover for towing a trailer, in particular, a lowboy trailer.

The means for towing comprise a tow arm 36. The tow arm 36 comprises a front section 38 and a rear section 40. The front section 38 is pivotally attached to the chassis of the truck 30 at a location between the front and rear sections 32 and 34 of the truck. The rear section 40 of the tow arm 36 protrudes from the rear of the truck 30. The front and rear sections 38 and 40 are arranged with respect to each other in a substantial perpendicular arrangement. In this manner, the rear section 40 of the tow arm 36 is oriented towards the ground which supports the truck 30. This allows the fastening of a truck to be towed to the rear section 40 of the tow arm 36.

The rear section 40 of the tow arm 36 comprises a tow attachment 42 for attachment of the trailer to be towed. The tow attachment 42 comprises a bumper adaptor 44. The bumper adaptor 44 is adapted to receive a bumper of the truck to be towed by the truck 30. The tow attachment 42 is pivotally attached to the rear section 40 of the tow arm 36. This allows selectively displacing the tow attachment 42 between an extended condition and a contracted condition. In the extend condition, the tow attachment 42 is capable to fasten the bumper of the truck to be towed to the truck 30. In the contracted condition, the tow attachment 42 is stowed such as to facilitate presenting the trailer to the rear of the truck for fastening of the gooseneck connection of the trailer to the truck 30.

The front section 38 of the tow arm 36 compromises a lifting frame. The lifting frame is defined by a pair of side beams 46a and 46b. The side beams 46 are arranged in a spaced apart relationship with respect to each other. In this manner, a clearance is defined between the pair of side beams 46.

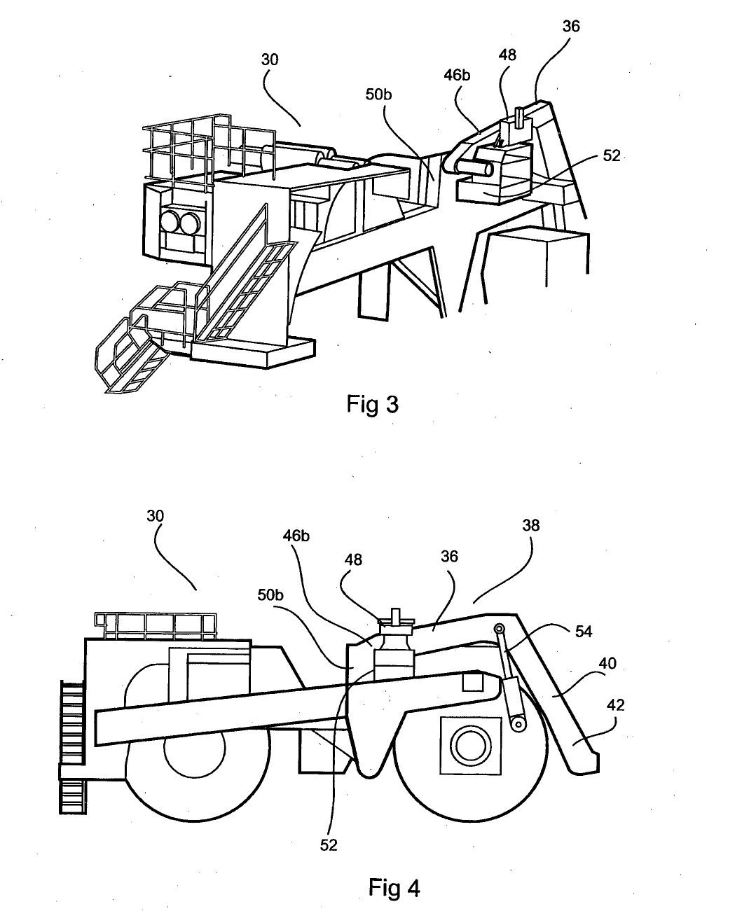

The side beams 46 are pivotally attached to the chassis of the truck 30. For this, the truck 30 comprises a pair of plate sections 50a and 50b. The plate sections 50 extend perpendicular to the chassis of the truck 30 and are arranged in a spaced apart relationship respect to each other. In this manner a space is defined between the plates 50. Between the plate sections 50 is arranged a base 52. The base 52 is fastened between the plate sections 50. FIG. 3 is a cross section of the truck 30 showing the base 52 attached to one of the plate sections 50. The base 52 comprises a hitch 48. The hitch 48 allows fastening of a gooseneck connection of a trailer to be towed by the truck after the truck 30 has been converted into a trailer prime mover.

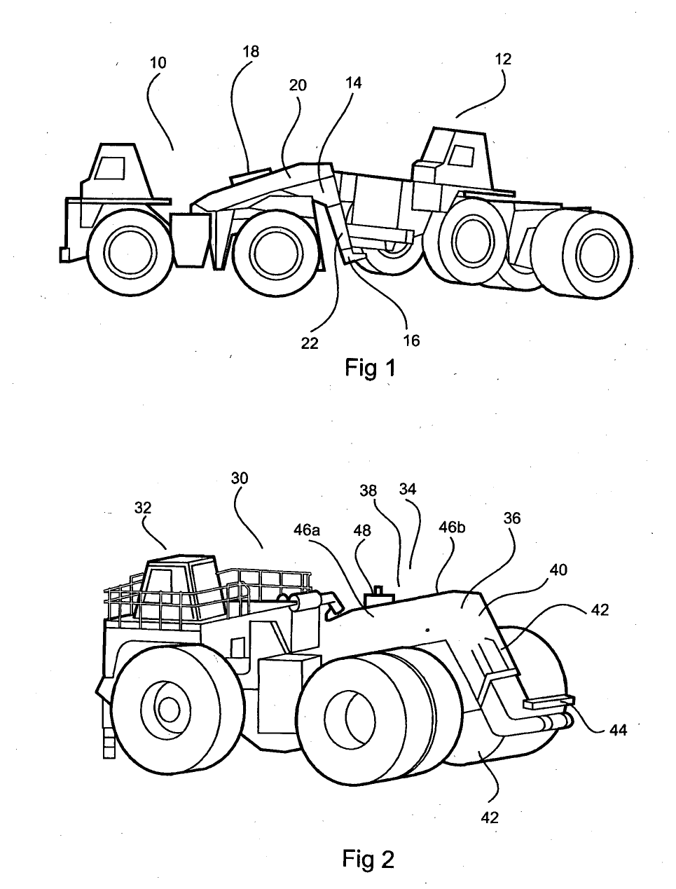

As mentioned before, the tow arm 36 is pivotally attached to the rear section 38 of the truck 30. In particular, each of the sides beams 46 of the rear section of the tow arm 36 are pivotally attached to each of the plate sections 50a and 50b. As shown in FIG. 3, the side beam 46b is attached to the plate section 50b. Similarly, as shown in FIG. 1, the side beam 46a is attached to the plate section 50a. This arrangement allows the tow arm 36 to be selectively displaced between the lowered position and the raised position.

Further, previously it was described that the side beams 46 are arranged such that a clearance is defined in the rear section 38 of the tow arm 36. This clearance allows for the hitch 48 to be attached to the base 52 because during pivoting of the tow arm 36 the hitch 48 passes through the clearance defined by the side beams 46 of the tow arm (see FIG. 3). Also, the clearance defined by the side beams 46 provides access to the hitch 48 when the tow arm 36 is in the lowered position. This allows the gooseneck connection (of the trailer to be towed) to be attached to the hitch 48. In this manner, the load applied due to the towing of the trailer is applied to the chassis of the truck 30.

The lowering and raising of the tow arm 36 is accomplished via hydraulic cylinder 54. An end of the cylinder 54 is attached to the tow arm 36; the other end of the tow arm 36 is attached to the chassis of the truck 30. Selectively varying the length of the cylinder 54 allows raising and lowering the tow arm 36.

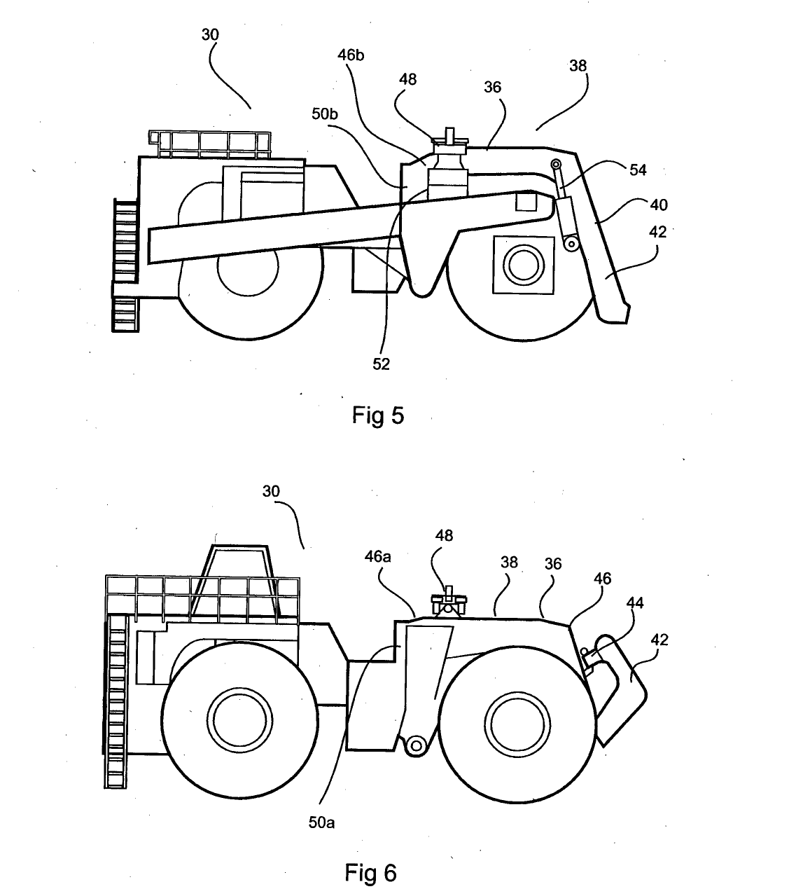

It was mentioned before that the truck 30 may function as a tow truck. When the truck 30 is used as tow truck the tow attachment 42 is in the extended condition. This allows fastening of the truck to be towed to the tow arm 36. During fastening of the truck to be towed, the tow arm 36 is located in the lowered position, (see FIG. 5) for attachment of the bumper of the truck to be towed to the tow attachment 42. After fastening of the truck to be towed, the tow arm 36 is positioned in the raised position for towing of the truck (see FIG. 3).

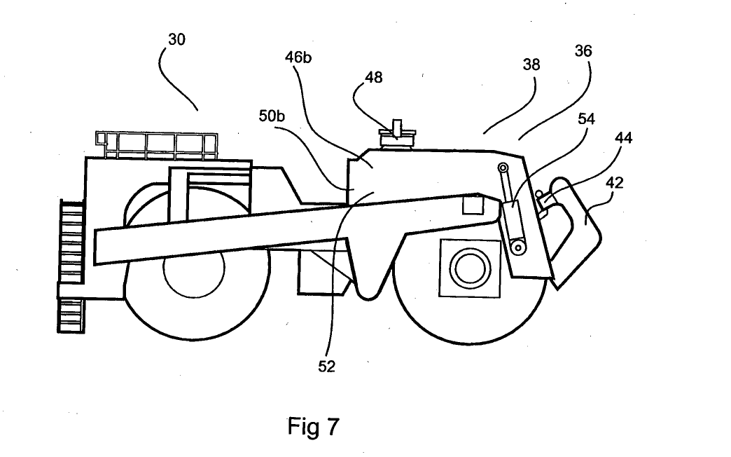

Alternatively, the truck 30 may function as a primer mover of a trailer such as a lowboy trailer. For this it is necessary to convert the truck 30 into a trailer prime mover. This conversion is accomplished by lowering and maintaining the tow arm 36 in the lowered position. Also, the tow attachment 42 is pivoted from the extended condition to the contracted condition (see FIGS. 6 and 7).

It is evident that the present embodiment provides a useful and advantageous truck for towing of vehicles as well for towing of a trailer, in particular, a lowboy trailer. This is particularly true in view that the hitch 48 is attached to the chassis of the truck 30 instead than being attached to the tow arm 36. The fact that the hitch 48 is attached to the chassis allows the load (applied to the truck during towing of the trailer) to be distributed to the chassis of the truck 30 instead than to the tow arm 36. Thus, there is no need to reinforce the lifting frame of the tow arm 36. This enables the lifting frame to be of a lighter construction. Also, the fact that the hitch 48 is mounted on the chassis of truck 30 allows the height of the truck hitch on the base 52 to be lower to the ground which in turn reduces the attachment height of the trailer. This also increase stability during towing of the trailer.

Further, the fact the tow attachment 42 is pivotally attached to the rear section 40 of the tow arm 36 allows the tow attachment 42 to be hinged up when used as a trailer operation hence allowing the lifting frame of the tow arm 36 to sit below the top of the hitch 48 on the base 52.

Moreover, the fact that the tow attachment 42 may be moved into a contracted condition is particularly useful because in the contracted condition the tow attachment 42 does not protrude from the rear of the truck 30. The fact the tow attachment 42 does not protrude from the rear of the vehicle facilitates attaching the gooseneck connection of the trailer to the hitch 48.

Modifications and variations as would be apparent to a skilled addressee are deemed to be within the scope of the present invention.

Further, it should be appreciated that the scope of the invention is not limited to the scope of the embodiments disclosed.

Throughout this specification, unless the context requires otherwise, the word “comprise” or variations such as “comprises” or “comprising”, will be understood to imply the inclusion of a stated integer or group of integers but not the exclusion of any other integer or group of integers.

1.-26. (canceled)

27. A tow vehicle comprising a chassis supported on a plurality of front and rear wheels, the tow vehicle comprising means for towing either a vehicle or a trailer, the means for towing comprising a tow arm adapted to receive the vehicle to be towed, and a hitch being attached to the chassis at a first location, the tow arm comprising a front section and a rear section, the front section being attached to the chassis at a second location, and the rear section being adapted to attach the vehicle to be towed, the front section of the tow arm being pivotally attached to the chassis at the second location to allow selectively displace the tow arm between a raised position and a lowered position, wherein the front section of the tow arm comprises a plurality of side beams arranged in a spaced apart relationship with respect to each other to define a clearance between the side beams.

28. The tow vehicle according to claim 27 wherein the hitch is located between the side beams to allow the hitch to traverse the clearance when the tow arm is either displaced into the raised position or into the lowered position.

29. The tow vehicle according to claim 27 wherein the chassis of the tow vehicle comprises a plurality of plate sections arranged in a spaced apart relationship with respect to each other, the hitch being attached between the plate sections and each of the side beams being attached to one of the plate sections such that the hitch is located between the side beams when the tow arm is in the lowered position.

30. The tow vehicle according to claim 29 wherein a support base is attached between the plate sections, the base being adapted to receive the hitch.

31. The tow vehicle according to claim 27 wherein the rear section of the tow arm comprises a tow attachment adapted to attach the vehicle to be towed.

32. The tow vehicle according to claim 31 wherein the tow attachment comprises a bumper adaptor for attaching the bumper of the vehicle to be towed.

33. The tow vehicle according to claim 31 wherein the tow attachment is adapted to be selectively displaced between a raised position and a lowered position.

34. The tow vehicle according to claim 31 wherein the tow attachment is pivotally attached to the rear section of the tow arm.

35. The tow vehicle according to claim 27 wherein the hitch is adapted to receive a gooseneck connection of a trailer.

36. The tow vehicle according to claim 27 wherein the trailer to be towed comprises a lowboy trailer.

37. The tow vehicle according to claim 27 wherein the vehicle to be towed comprises a large dump truck.

38. A towing means for attachment to a chassis of a tow vehicle, the chassis being supported on a plurality of front and rear wheels, the towing means comprising a tow arm and a hitch, the hitch being adapted to be attached to the chassis at a first location, the tow arm comprising a front section and a rear section, the front section being adapted to be attached to the chassis at a second location, the rear section being adapted to attach the vehicle to be towed and the front section of the tow arm is adapted to be pivotally attached to the chassis, wherein the front section of the tow arm comprises a plurality of side beams arranged in a spaced apart relationship with respect to each other to define a clearance between the side beams, the clearance providing access to the hitch.

39. The towing means according to claim 38 wherein the first and second locations are located between the front and rear wheels.

40. A tow arm for attachment to a tow vehicle comprising a chassis supported on a plurality of front and rear wheels, the tow arm comprising a front section and a rear section, the front section being adapted to be pivotally attached to a first location of the chassis and the rear section being adapted to attach a vehicle to be towed, wherein the front section comprises a plurality of side beams arranged in a spaced apart relationship with respect to each other to define a clearance between the side beams to provide access to a hitch attached at a second of the chassis.

41. The tow arm according to claim 40 wherein the first and second locations are located between the front and rear wheels.

42. The tow arm according to claim 40 wherein the rear section of the tow arm comprises a tow attachment adapted to attach the vehicle to be towed, wherein the tow attachment is pivotally attached to the rear section of the tow arm.
